(19) United States
(12) Patent Application Publication
(10) Pub. No.: US 2014/0125788 A1
(43) Pub. Date: May 8, 2014

(54) FINGERPRINT IMAGE CAPTURING SYSTEM

(71) Applicant: GINGY TECHNOLOGY INC., HSINCHU CITY (TW)

(72) Inventor: Chien-Hsing WU, Kaohsiung City (TW)

(73) Assignee: GINGY TECHNOLOGY INC., HSINCHU CITY (TW)

(21) Appl. No.: 14/020,328

(22) Filed: Sep. 6, 2013

(30) Foreign Application Priority Data
Nov. 2, 2012 (TW) 101140886

(51) Int. Cl. G06K 9/00

(52) U.S. Cl. CPC G06K 9/0004
USPC 348/77

(57) ABSTRACT

A fingerprint image capturing system includes a fingerprint touch apparatus. The fingerprint touch apparatus includes a top surface, a bottom surface, a first normal line, a second normal line, a light input surface and a light output surface. The first normal line is perpendicular to the top surface. The light input surface and the light output surface are located on two opposite sides of the fingerprint touch apparatus. The light input surface corresponds to a planar light source module and the light output surface corresponds to an image capturing module. The planar light source module includes a light-emitting plane, and the light-emitting plane is parallel to the first normal line. The second normal line is perpendicular to the light-emitting plane. The second normal line and the light input surface form a first angle therebetween. The range of the first angle falls within 30 degrees to 45 degrees.

### CROSS-REFERENCE TO RELATED APPLICATIONS

This non-provisional application claims priority under 35 U.S.C. §119(a) on Patent Application No(s). 101140886 filed in Taiwan, R.O.C. On Nov. 2, 2012, the entire contents of which are hereby incorporated by reference.

### Technical Field

The disclosure relates to an image capturing system, more particularly to a fingerprint image capturing system for capturing fingerprint image.

### Background

In general, the fingerprint recognition apparatus reads information about people's fingerprints by scanning their fingerprints on the apparatus. For example, when the finger touches a fingerprint touch plate, several light sources emit light for the lens to capture the fingerprint image. Because the angles between the lens and fingers, and the angles between the light source and fingers have to be adjusted to specific angles for achieving total reflection so that the fingerprint recognition apparatus can capture a clear and distinct fingerprint. Therefore, the optical fingerprint recognition apparatus in the prior art not only are large in size but also have dark zones in the vicinity of the fingerprint image.

### SUMMARY

An embodiment of the disclosure provides a fingerprint image capturing system comprising a fingerprint touch apparatus. The fingerprint touch apparatus includes a top surface, a bottom surface, a first normal line, a second normal line, a light input surface and a light output surface. The first normal line is perpendicular to the top surface. The light input surface and the light output surface are located on two opposite sides of the fingerprint touch apparatus. The light input surface corresponds to a planar light source module and the light output surface corresponds to an image capturing module. The planar light source module includes a light-emitting plane, and the light-emitting plane is parallel to the first normal line. The second normal line is perpendicular to the light-emitting plane and forms a first angle with the light input surface. The range of the first angle falls within 30 degrees to 45 degrees.

### BRIEF DESCRIPTION OF THE DRAWINGS

The present invention will become more fully understood from the detailed description given herein below along with the accompanying drawings which are for illustration only, thus are not limitative of the present invention, and wherein:

FIG. 1 and FIG. 2 are schematic views of a fingerprint image capturing system according to an embodiment of the disclosure;

FIG. 3 is a view of a refraction path of light emitted from a point light source inside a finger touch apparatus; and

FIG. 4 is a view of a fingerprint image captured by the fingerprint image capturing system according to the embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

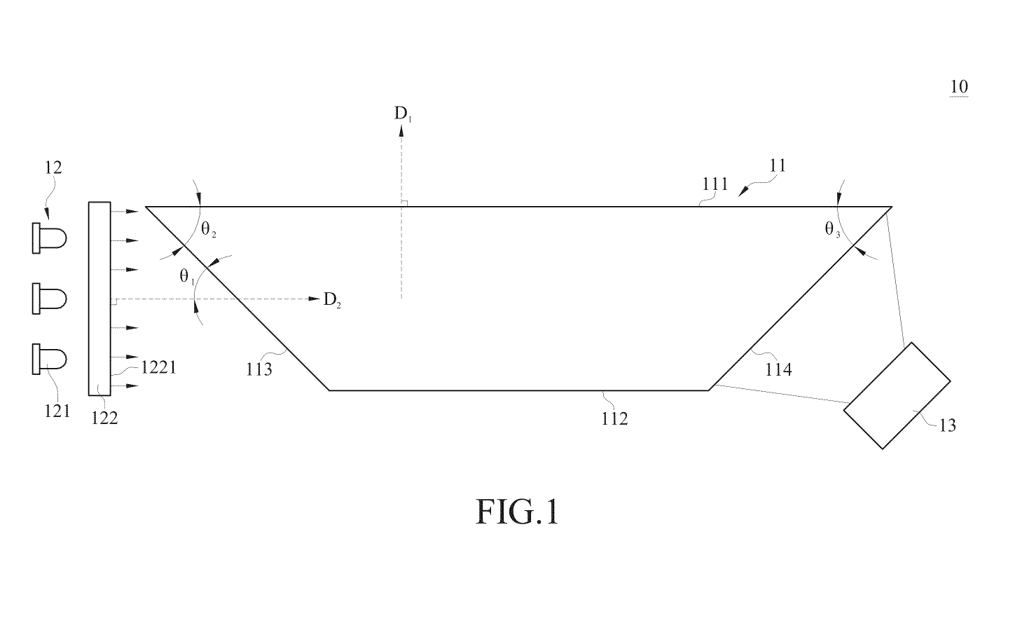

Please refer to FIG. 1, which is a schematic view of a fingerprint image capturing system according to an embodiment of the disclosure. The fingerprint image capturing system 10 of the disclosure comprises a finger touch apparatus 11, a planar light source module 12 and an image capturing module 13. The finger touch apparatus 11 is a transparent or translucent board and the material of the finger touch apparatus 11 is glass (model number: BK7) or acrylic (polymethylmethacrylate, PMMA). The range of the refraction coefficient n₂ of the fingerprint touch apparatus 11 falls within 1.49 to 1.52.

The shape of the cross section of the finger touch apparatus 11 is a trapezoid. The finger touch apparatus 11 comprises a top surface 111, a bottom surface 112, a light input surface 113 and a light output surface 114. The finger touch apparatus 11 is used for being touched by a finger and the width of the top surface 111 is wider than that of the bottom surface 112. The light input surface 113 and the light output surface 114 are located on two opposite sides of the finger touch apparatus 11 respectively and are both connected between the top surface 111 and the bottom surface 112.

The planar light source module 12 comprises a plurality of point light sources 121 and a diffusing plate 122. The diffusing plate 122 includes a light-emitting plane 1221, which corresponds to the light input surface 113. It is worth noting that a first normal line D1 is defined on the top surface 111 where the first normal line D1 is perpendicular to the top surface 111 of the finger touch apparatus 11, and is parallel to the light-emitting plane 1221. Moreover, a second normal line D2 is defined on the light-emitting plane 1221 and the second normal line D2 is perpendicular to the light-emitting plane 1221. The second normal line D2 and the light input surface 113 form a first angle θ₁ therebetween. The range of the first angle θ₁ falls within 30 degrees to 45 degrees. In one embodiment of the disclosure, the first angle θ₁ is 45 degrees.

When the first angle θ₁ falls within 30 degrees to 45 degrees, the light input surface 113 and the top surface 111 form a second angle θ₂ with a range that falls within 30 degrees to 45 degrees. Likewise, the light output surface 114 and the top surface 111 form a third angle θ₃ with a range that falls within 30 degrees to 45 degrees.

The lights emitted from the point light sources 121 are uniformized by the diffusing plate 122 when the point light sources 121 emit the lights toward the diffusing plate 122. Afterwards, the light-emitting plane 1221 produces a uniform planar light source and all the lights emitted from the planar light source enter the light input surface 113 in a specific direction which is parallel to the second normal line D2. Accordingly, the light emitted from the planar light source is refracted to and spreads all over the top surface 111 including the edges of the top surface 111, so the whole area of the top surface 111 receives the light evenly.

The image capturing module 13 corresponds to the light output surface 114 and the image capturing module 13 is used to capture the image generated by the light reflected from the top surface 111.

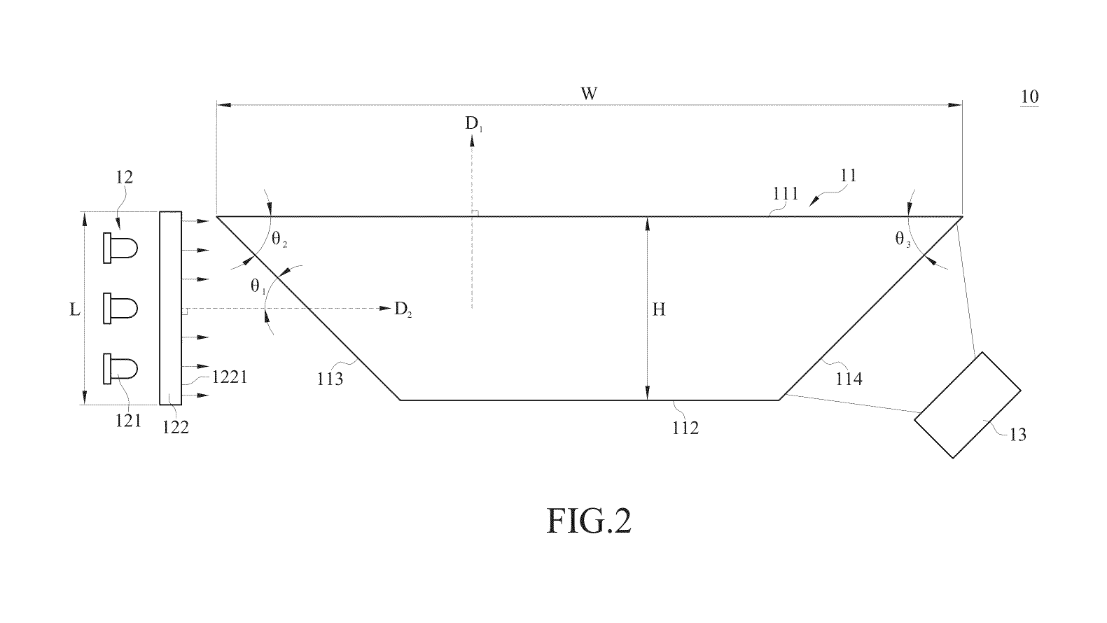

Please refer to FIG. 2, which is a schematic view of a fingerprint image capturing system according to an embodiment of the disclosure. A width W is further defined on the top surface 111, and the top surface 111 and the bottom surface 112 are separated by a height H. Moreover, a length L is defined along the light-emitting plane 1221, and the length L of the light-emitting plane 1221 is equal to the height H of the finger touch apparatus 11.

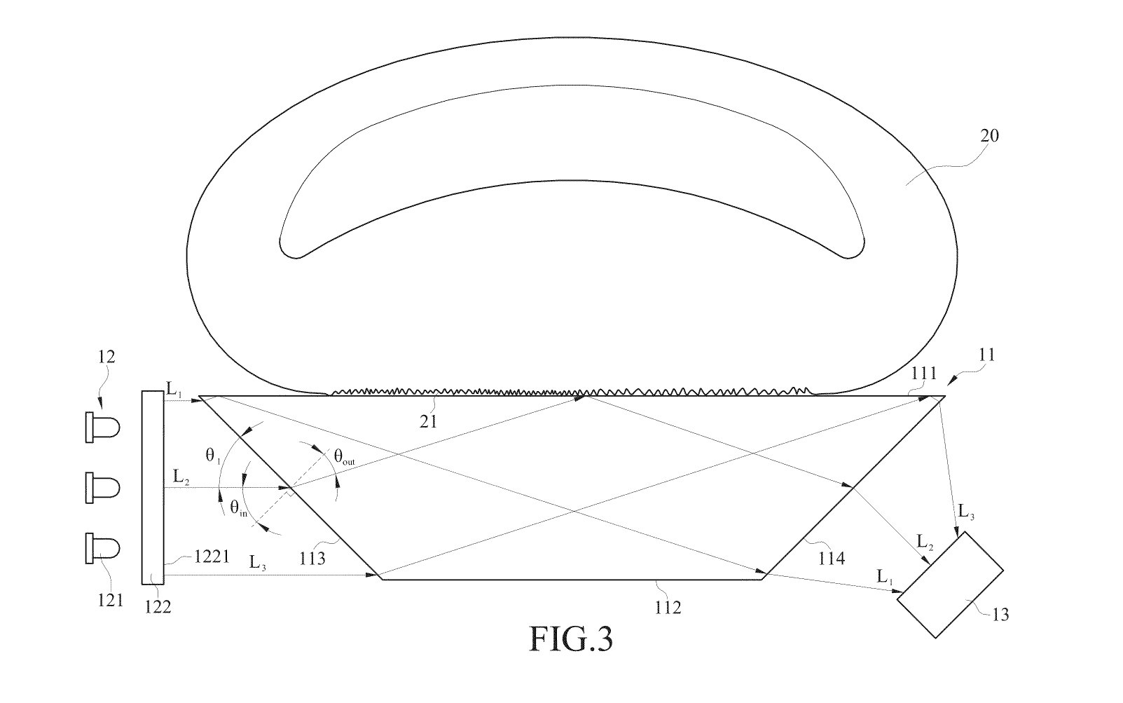

Please refer to FIG. 3, which is a view of a refraction path of a light emitted from a point light source inside a finger touch apparatus. Only three of the lights L1, L2 and L3 emitted from the planar light source are illustrated for representing the light entering the upper, middle and lower portions of the light-emitting plane 1221. When the lights L1, L2 and L3 enter the light input surface 113 in a specific direction, which is parallel to the second normal line D2 (illustrated in FIG. 2), the first angles θ₁ are formed between the lights L1, L2, L3 and the light input surface 113, respectively. For example, when the first angle θ₁ is 45 degrees, the incident angle θᵢₙ of the lights L1, L2 and L3 can be estimated as being 45 degrees. Furthermore, if the refraction coefficient n₂ of the finger touch apparatus 11 is 1.5168 whereas the refraction coefficient n₁ of the air is 1, the refraction angle θₒᵤₜ can be estimated as being 27.78 degrees according to the formula sin θᵢₙ=1.5168 sin θₒᵤₜ, which enables the lights L1, L2 and L3 to enter the top surface 111 at 27.78 degrees of the incident angle.

Therefore, according to the refraction path of the lights L1, L2 and L3 illustrated in FIG. 3, the lights L1 and L3 are refracted to the far left side and the far right side of the top surface 111, respectively. In other words, the lights of the planar light source, emitted from the light-emitting plane 1221, are uniformly refracted to and spread all over the top surface 111, which enables the top surface 111 to uniformly receive the lights. The fingerprint 21 on the finger 20 becomes well-defined after receiving the uniform light from the top surface 111, such that the image capturing module 13 may clearly capture the fingerprint 21 image reflected from the top surface 111.

In addition, if the lights L1, L2 and L3 enter the light input surface 113 with a specific angle which is parallel to the second normal line D2, and the first angles θ₁ are 30 degrees between the lights L1, L2, L3 and the light input surface 113, the incident angles θᵢₙ in of the lights L1, L2 and L3 are estimated as being 60 degrees. If the refraction coefficient n₂ of the finger touch apparatus 11 is 1.5168 whereas the refraction coefficient n₁ of the air is 1, the refraction angle θₒᵤₜ out can be estimated as being 34.81 degrees according to the formula sin θᵢₙ=1.5168 sin θₒᵤₜ, which enables the lights L1, L2 and L3 to enter the top surface 111 by 34.81 degrees of the incident angle.

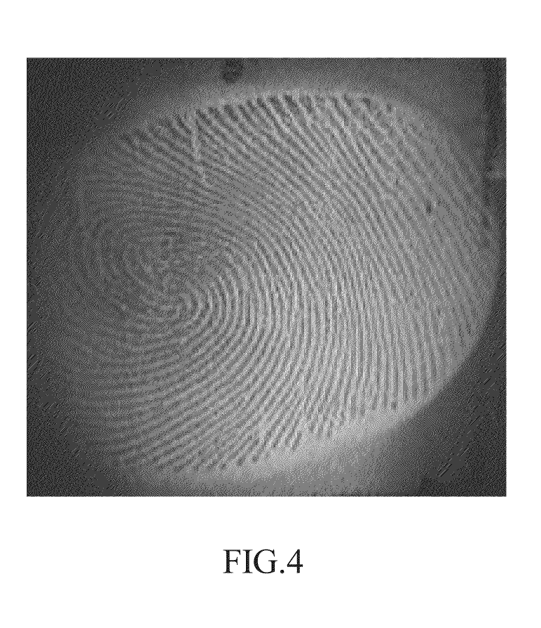

Therefore, in order to produce a high quality image capturing module 13, the range of the refraction angle θₒᵤₜ of the lights L1, L2 and L3, emitted from the point light sources, falls within 34.81 degrees to 27.78 degrees. Moreover, the length L of the light-emitting plane 1221 is equal to the height H of the finger touch apparatus 11. The ratio of the width W to the height H of the finger touch apparatus 11 is 5 to 2 in order to have better capturing width (i.e., the width W of the top surface 111) and the capturing angles. For example, when the thickness of the finger touch apparatus 11 is 8 mm, the maximum capturing width W is 20 mm and the range of the refraction angle θₒᵤₜ of the lights L1, L2 and L3, emitted from the planar light sources, falls within 34.81 degrees to 27.78 degrees, such that the top surface 111 may uniformly receive the lights. Therefore, please refer to the FIG. 4, which is a view of a fingerprint image captured by the fingerprint image capturing system according to an embodiment of the disclosure. In addition to capturing a uniform and clear fingerprint image by the image capturing module 13, there are no dark zones in the vicinity of the fingerprint image. Whereas, the fingerprint image capturing system in the prior art has a lower brightness along the two opposite sides than the brightness of the central area. The fingerprint image capturing system in this disclosure solves the problem of having dark spots within the fingerprint image.

What is claimed is:

1. A fingerprint image capturing system, comprising a fingerprint touch apparatus having a top surface, a bottom surface, a first normal line, a light input surface and a light output surface, wherein the top surface and the bottom surface are opposite to each other, wherein the first normal line is perpendicular to the top surface, the light input surface and the light output surface are located on two opposite sides of the fingerprint touch apparatus, wherein the light input surface corresponds to a planar light source module and the light output surface corresponds to an image capturing module, and the fingerprint image capturing system is characterized by:
the planar light source module having a light-emitting plane, wherein the light-emitting plane is parallel to the first normal line, wherein a second normal line is perpendicular to the light-emitting plane, the second normal line and the light input surface form a first angle therebetween, wherein the range of the first angle falls within 30 degrees to 45 degrees.

2. The fingerprint image capturing system according to claim 1, wherein the light input surface and the top surface form a second angle and the range of the second angle falls within 30 degrees to 45 degrees, wherein the light output surface and the top surface form a third angle therebetween, and the range of the third angle falls within 30 degrees to 45 degrees.

3. The fingerprint image capturing system according to claim 1, wherein the planar light source module further comprises:
a diffusing plate having the light-emitting plane; and
a plurality of point light sources corresponding to the diffusing plate, wherein the light emitted from the point light sources passes through the diffusing plate to form a planar light source.

4. The fingerprint image capturing system according to claim 3, wherein the material of the fingerprint touch apparatus is glass or acrylic, and the range of the refraction coefficient of the fingerprint touch apparatus falls within 1.49 to 1.52.

5. The fingerprint image capturing system according to claim 4, wherein the angle of refraction of the light from the planar light source entering the light input surface falls within 34.81 degrees to 27.78 degrees.

6. A fingerprint image capturing system, comprising a fingerprint touch apparatus having a top surface, a bottom surface, a height, a light input surface and a light output surface, wherein the top surface and the bottom surface are opposite to each other, the top surface and the bottom surface are separated by a height, the light input surface and the light output surface are located on two opposite sides of the fingerprint touch apparatus, wherein the light input surface corresponds to a planar light source module and the light output surface corresponds to an image capturing module, and the fingerprint image capturing system is characterized by:
the planar light source module having a light-emitting plane, wherein a length is defined along the light-emitting plane, and the length of the light-emitting plane is equal to the height of the fingerprint touch apparatus, wherein a second normal line is perpendicular to the light-emitting plane, the second normal line and the light input surface forming a first angle, wherein the range of the first angle falls within 30 degrees to 45 degrees.

7. The fingerprint image capturing system according to claim 6, wherein the light input surface and the top surface form a second angle and the range of the second angle falls within 30 degrees to 45 degrees, wherein the light output surface and the top surface form a third angle and the range of the third angle falls within 30 degrees to 45 degrees.

8. The fingerprint image capturing system according to claim 6, wherein a first normal line is perpendicular to the top surface, wherein the planar light source module further comprises:
a diffusing plate having the light-emitting plane, wherein the light-emitting plane is parallel to the first normal line; and
a plurality of point light sources corresponding to the diffusing plate, wherein the light emitted from the point light sources passes through the diffusing plate to form a planar light source.

9. The fingerprint image capturing system according to claim 8, wherein the material of the fingerprint touch apparatus is glass or acrylic, and the range of the refraction coefficient of the fingerprint touch apparatus falls within 1.49 to 1.52.

10. The fingerprint image capturing system according to claim 9, wherein the top surface has a width, the ratio of the width to the height of the fingerprint touch apparatus is 5 to 2, and the refraction angle of the light from the planar light source entering into the light input surface falls within 34.81 degrees to 27.78 degrees.
